(19) United States
(12) Patent Application Publication
(10) Pub. No.: US 2023/0328298 A1
(43) Pub. Date: Oct. 12, 2023

(54) DISPLAY DEVICE AND OPERATION METHOD THEREOF

(71) Applicant: Samsung Electronics Co., Ltd., Suwon-si (KR)

(72) Inventors: Nayoung KIM, Suwon-si (KR); Sungsik PARK, Suwon-si (KR); Jonghee YUN, Suwon-si (KR); Jeonghun PARK, Suwon-si (KR); Sohee CHOI, Suwon-si (KR)

(21) Appl. No.: 18/327,570

(22) Filed: Jun. 1, 2023

Related U.S. Application Data
(63) Continuation of application No. PCT/KR2021/017924, filed on Nov. 30, 2021.

(30) Foreign Application Priority Data
Dec. 1, 2020 (KR) 10-2020-0165944

(51) Int. Cl. H04N 21/8547; H04N 21/234; H04N 21/422; H04N 21/433

(52) U.S. Cl. CPC H04N 21/23418; H04N 21/42201; H04N 21/4333; H04N 21/8547

(57) ABSTRACT

A display device may include: a display; an image input unit configured to obtain video content; a detector including at least one sensor; and a processor which may be configured to execute at least one instruction. The processor may be configured to, by executing the at least one instruction, detect a gesture of a user based on a result of detection by the at least one sensor while the video content is reproduced, and control the reproduction of the video content such that at least one frame corresponding to the detected gesture among a plurality of frames included in the video content is displayed on the display.

### CROSS-REFERENCE TO RELATED APPLICATIONS

This application is a continuation of International Application No. PCT/KR2021/017924, filed on Nov. 30, 2021, designating the United States, in the Korean Intellectual Property Receiving Office, and claiming priority to KR 10-2020-0165944, filed Dec. 1, 2020, the disclosures of which are all hereby incorporated by reference herein in their entireties.

### BACKGROUND

### Field

Certain example embodiments relate to a display device for reproducing video content, and/or an operation method of the display device.

For example, certain example embodiments relate to a display device for reproducing video content that induces a user to make a certain motion, and/or an operation method of the display device.

### Description of Related Art

With the distribution of displays and the development of technologies, display devices having various forms and functions have been developed.

Accordingly, functions meeting various needs or intentions of consumers may be implemented by using a display device.

The display device may be connected to various wired or wireless communication networks to receive at least one of a plurality of pieces of content through the connected communication network. Recently, the types and number of content items that may be reproduced through a display device have become significantly diverse. For example, a display device may access at least one server through the Internet, receive at least one piece of content from the connected at least one server, and display the content. In addition, the display device may select, receive, and display at least one of various types of pieces of content from an external device connected via various wired/wireless networks, such as a broadcasting station server, an Internet server, a content server, a content providing device, or a content storage device.

Examples of content received and reproduced by the display device may include content for home trainings, dance-related content, dance lesson content, and health care-related content. The above-described content is to provide movements that are continuously performed in exercise or dance.

For example, home training content is to express an exercise that may be performed in an indoor space (e.g., at home) with a tool that is easily usable by a user or without a separate tool. The user of the display device may easily exercise even indoors by following exercise movements expressed in the home training content while watching the home training content.

The above-described home training content is generally reproduced through a display device without separately controlling the reproduction speed. Accordingly, there is an inconvenience that, when the user cannot follow a movement expressed in the home training content at the right moment, the user has to pause or resume the reproduction of the home training content by using a separate control device.

### SUMMARY

Certain example embodiments provide a display device capable of increasing user satisfaction in watching video content, and/or an operation method of the display device.

Certain example embodiments provide a display device capable of increasing user satisfaction by automatically adjusting reproduction of video content according to a user following the video content, and/or an operation method of the display device.

A display device and an operation method thereof according to certain example embodiments may automatically adjust reproduction of video content according to a user following the video content. Accordingly, it is possible to increase the satisfaction of the user watching the video content.

A display device according to an example embodiment may include: a display; an image input unit configured to obtain video content; a detector including at least one sensor; and a processor configured to execute at least one instruction. The processor may further be configured to, by executing the at least one instruction, detect a gesture of a user based on a result of detection by the at least one sensor while the video content is reproduced, and control the reproduction of the video content such that at least one frame corresponding to the detected gesture among a plurality of frames included in the video content is displayed.

In addition, the processor may identify a plurality of different movements included in the video content and control the reproduction of the video content such that the at least one frame showing a movement corresponding to the detected gesture among the plurality of movement is displayed.

In addition, the processor may pause the reproduction of the video content such that the at least one frame corresponding to the detected gesture among the plurality of frames included in the video content is displayed on the display.

In addition, the processor may adjust the reproduction speed of the video content such that the at least one frame corresponding to the detected gesture among the plurality of frames included in the video content is displayed on the display.

In addition, the processor may move the reproduction point of the video content such that the at least one frame corresponding to the detected gesture among the plurality of frames included in the video content is displayed on the display.

In addition, the processor may analyze the video content to distinguish between a plurality of different movements included in the video content, obtain information about reproduction time periods of the plurality of distinguished movements, and control, based on the information about the reproduction time periods, the at least one frame corresponding to the detected gesture among the plurality of frames included in the video content, to be displayed on the display.

In addition, the processor may analyze the video content to identify a plurality of different movements included in the video content, and perform control such that tagged video content is generated by inserting at least one tag corresponding to each of the identified plurality of movements into the video content.

In addition, the processor may control, based on the plurality of tags, the at least one frame corresponding to the detected gesture among the plurality of frames included in the video content, to be displayed on the display.

In addition, the processor may input the result of the detection by the detector into a neural network and obtain information about the gesture of the user, which is information that is output as a result of computation through the neural network.

In addition, the processor may obtain an image corresponding to the detected gesture and control the obtained image to be displayed to be superimposed on a reproduction screen of the video content.

In addition, the processor may control guide information about the detected gesture, to be displayed on a reproduction screen of the video content.

An operation method of a display device according to an example embodiment may include: reproducing video content through a display; detecting a gesture of a user based on a result of detection by at least one sensor while the video content is being reproduced; and controlling reproduction of the video content such that at least one frame corresponding to the detected gesture among a plurality of frames included in the video content is displayed.

In addition, the operation method of the display device according to an example embodiment may further include identifying a plurality of different movements included in the video content. In addition, the controlling of the reproduction may include displaying, on the display, the at least one frame showing a movement corresponding to the detected gesture among the identified plurality of movements.

In addition, the controlling of the reproduction may include performing at least one of adjusting a reproduction speed of the video content, moving a reproduction point of the video content, and pausing the reproduction of the video content, such that the at least one frame corresponding to the detected gesture among the plurality of frames included in the video content is displayed on the display.

In addition, the operation method of the display device according to an example embodiment may further include analyzing the video content to identify a plurality of different movements included in the video content and obtaining information about reproduction time periods of the identified plurality of movements. In addition, the controlling of the reproduction may include, based on the information about the reproduction time periods, displaying, on the display, the at least one frame showing a movement corresponding to the detected gesture among the plurality of movements.

In addition, the operation method of the display device according to an example embodiment may further include analyzing the video content to identify a plurality of different movements included in the video content, and performing control such that tagged video content is generated by inserting at least one tag corresponding to each of the identified plurality of movements into the video content.

In addition, the operation method of the display device according to an example embodiment may further include obtaining an image corresponding to the detected gesture and controlling the obtained image to be displayed to be superimposed on a reproduction screen of the video content.

In addition, the operation method of the display device according to an example embodiment may further include displaying guide information about the detected gesture, on the reproduction screen of the video content.

### BRIEF DESCRIPTION OF DRAWINGS

The above and other aspects, features, and advantages of certain example embodiments will be more apparent from the following detailed description, taken in conjunction with the accompanying drawings, in which:

FIG. 1 is a diagram for describing video content that induces a user to make a certain movement.

FIG. 2 is a block diagram illustrating a display device according to an example embodiment.

FIG. 3 is another block diagram illustrating a display device according to an example embodiment.

FIG. 4 is a flowchart illustrating an operation method of a display device according to an example embodiment.

FIG. 5 is another block diagram illustrating a display device according to an example embodiment.

FIG. 6 is a diagram for describing video content reproduced by a display device according to an example embodiment.

FIG. 7 is a diagram for describing images output on a screen according to an example reproduction of video content.

FIG. 8 is another diagram for describing images output on a screen according to an example reproduction of video content.

FIG. 9 is another diagram for describing images output on a screen according to an example reproduction of video content.

FIG. 10 is a diagram illustrating example movements shown in video content reproduced during respective time periods.

FIG. 11 is a diagram for describing tags of video content used in an example embodiment.

FIG. 12 is a diagram for describing an operation of detecting a gesture in an example embodiment.

FIG. 13 is another diagram for describing an operation of detecting a gesture in an example embodiment.

FIG. 14 is another flowchart illustrating an operation method of a display device according to an example embodiment.

FIG. 15 is a diagram for describing a server communicating with a display device according to an example embodiment.

FIG. 16 is a diagram for describing an operation of adjusting reproduction of video content according to an example embodiment.

### DETAILED DESCRIPTION

Hereinafter, embodiments of the present disclosure are described in detail with reference to the accompanying drawings for those of skill in the art to be able to implement the embodiments without any difficulty. The present disclosure may, however, be embodied in many different forms and should not be construed as being limited to the embodiments set forth herein. In order to clearly describe the present disclosure, portions that are not relevant to the description of the present disclosure are omitted, and similar reference numerals are assigned to similar elements throughout the present specification. In addition, the same reference numerals designate the same components throughout the drawings.

Throughout the present specification, when a part is referred to as being “connected to” another part, it may be “directly connected to” the other part or be “electrically connected to” the other part through an intervening element(s). In addition, when an element is referred to as “including” a component, the element may additionally include other components rather than excluding other components as long as there is no particular opposing recitation.

As used herein, phrases such as “in some embodiments” or “in an embodiment” does not necessarily indicate the same embodiment.

Some embodiments may be represented by functional blocks and various processing operations. Some or all of the functional blocks may be implemented by any number of hardware and/or software elements that perform particular functions. For example, the functional blocks of the present disclosure may be implemented by using one or more processors or microprocessors, or circuit elements for performing intended functions. For example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as ‘module’ or ‘component’ may be used broadly and may not be limited to mechanical and physical elements.

In addition, connection lines or connection members between components illustrated in the drawings are merely exemplary of functional connections and/or physical or circuit connections. Various alternative or additional functional connections, physical connections, or circuit connections between components may be present in a practical device.

In addition, the expression ‘at least one of a, b, and c’ indicates only a, only b, only c, both a and b, both a and c, both b and c, or all of a, b, and c.

In an example embodiment, the term ‘display device’ may refer to any electronic device capable of receiving a video signal corresponding to video content, and reproducing the video content.

In detail, in an example embodiment, a display device may be a television (TV), a digital TV, a smart TV, a digital signage, a digital signboard, a smart phone, a tablet personal computer (PC), a personal digital assistant (PDA), a laptop computer, a media player, or the like.

Hereinafter, a display device and an operation method thereof according to embodiments of the present disclosure will be described in detail with reference to the accompanying drawings. In the accompanying drawings, like elements are illustrated by using like reference numerals. In addition, throughout the detailed description, the same components are described with the same terms.

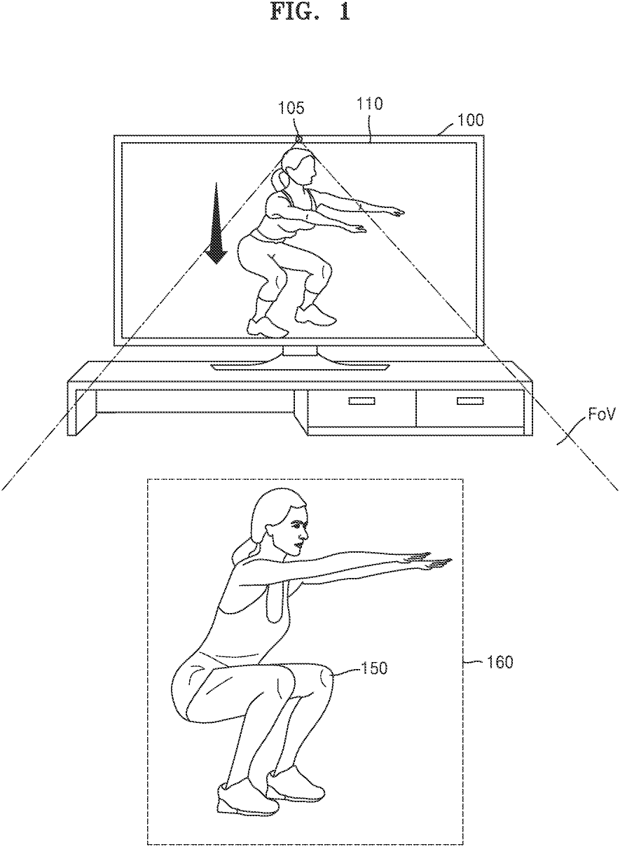

Hereinafter, a configuration of a display device according to an example embodiment and operations performed by the display device will be described in detail with reference to FIGS. 1 to 16.

FIG. 1 is a diagram for describing video content that induces a user to make a certain movement.

With the development of image technology, personal broadcasting, and professional image applications, various types of image content and image-based services have been provided. Such image content and image-based services may be provided through a display device. Here, the image content may include video content, and such video content may be reproduced or output through a display device.

For example, the video content may be content showing movements related to at least one of dance, workout, exercise therapy, and home trainingtraining. As another example, the video content may be instructional content for teaching or guiding viewers on movements related to at least one of dance, workout, exercise therapy, and home training. When the above-described video content is reproduced by a display 110 of a display device 100, a user may move according to the movements shown in the video content.

Referring to FIG. 1, video content reproduced by the display device 100 may be home training content showing squat movements. In this case, the display device 100 may reproduce the video content by displaying or outputting, through the display 110 in real time, images showing the squat movements. Then, a user 150 may watch the video content reproduced on the display 110 and follow the squat movements.

As described above, when video content for showing or instructing at least one movement is reproduced by the display device 100, the video content is generally reproduced regardless of the state of the user. For example, in a case in which a movement shown in the video content is not easy to follow, the user may be unable to follow the movement or may miss the movement. Alternatively, in a case in which a movement shown in the video content is not easy to follow, the user may follow the movement slowly, and thus may be unable to follow in real time a change in the movement according to the reproduction speed of the video content.

Embodiments of the present disclosure provides a display device capable of automatically adjusting reproduction of video content according to a user following the video content in order to reduce the user’s difficulty and inconvenience that occur when the user cannot properly follow a movement shown in the video content as described above, and an operation method of the display device.

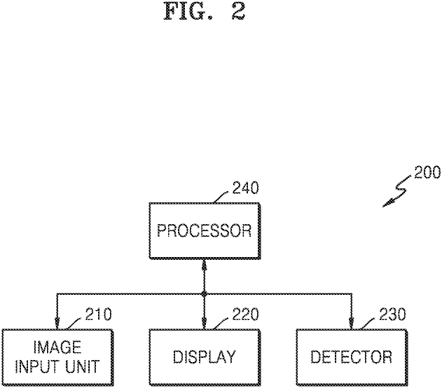

FIG. 2 is a block diagram illustrating a display device according to an example embodiment. A display device 200 illustrated in FIG. 2 corresponds to the display device 100 described above with reference to FIG. 1, and thus, redundant descriptions thereof will be omitted.

In an example embodiment, the display device 200 may include any electronic device that visually displays video content. In detail, the display device 200 may be any electronic device capable of selectively displaying at least one piece of video content, and may be in any one of various forms, such as a TV, a digital broadcasting terminal, a tablet PC, a smart phone, a mobile phone, a computer, or a notebook computer. Also, the display device may be of a fixed type, a movable type, or a portable type.

Referring to FIG. 2, the display device 200 includes an image input unit 210 comprising communication circuitry, a display 220, a detector 230, and a processor 240.

In detail, the display device 200 includes the display 220, the image input unit 210 configured to obtain video content, the detector 230 including at least one sensor, and the processor 240 configured to execute at least one instruction. Here, the processor 240 executes the at least one instruction to detect a gesture of the user based on a result of detection by the at least one sensor while the video content is reproduced, and control the reproduction of the video content such that at least one frame corresponding to the detected gesture among a plurality of frames included in the video content is displayed through the display.

In detail, the image input unit 210 may obtain video content.

Here, the video content may be content showing a certain movement. For example, the video content may be content including a material showing a movement related to at least one of dance, workout, exercise therapy, and home training. As another example, the video content may be instructional content for teaching or guiding viewers on a movement related to at least one of dance, workout, exercise therapy, and home training. As another example, the video content may be content including a material showing a movement for expressing a language or a sign with a motion or a gesture of a human body, such as a hand sign.

In addition, an object appearing in the video content may be a person showing a movement, a text describing a movement, a virtual object, a virtual avatar, a virtual character, or the like.

The image input unit 210 may receive image data from the outside of the display device 200. Here, the image data may be video data corresponding to video content that includes a material showing a movement. That is, the video content may be input, transmitted, or delivered in the form of moving picture data or video data.

For example, the image input unit 210 may receive at least one piece of video content transmitted through a certain channel, by communicating with an external device (not shown). In detail, the image input unit 210 may receive at least one of a plurality of pieces of content corresponding to a plurality of channels. Here, the channel may be a broadcast channel. In addition to the broadcast channel, the channel may refer, for example, to a content transmission path corresponding to a content provider that transmits certain content. For example, in addition to the broadcast channel, the channel may refer, for example, to a transmission path through which a video-on-demand (VoD) service and/or a streaming content providing service are/is transmitted, and may be represented in the form of a certain number, a certain character, or a combination of characters and numbers like a broadcast channel. For example, the image input unit 210 may receive video content from a sports channel that provides video content for home training.

In detail, the image input unit 210 may communicate with an external device (not shown) through a wired or wireless network. The image input unit 210 according to an embodiment includes at least one communication module, such as a short-distance communication module, a wired communication module, a mobile communication module, and a broadcast receiving module, to perform communication through a wired/wireless network. For example, the at least one communication module refers to a communication module capable of performing data transmission and reception through a network conforming to communication standards, such as a tuner that performs broadcast reception, Bluetooth, a wireless local area network (WLAN) (e.g., Wi-Fi), wireless broadband (Wibro), Worldwide Interoperability for Microwave Access (WiMAX), code-division multiple access (CDMA), or wideband CDMA (WCDMA).

In addition, the image input unit 210 may include one of a high-definition multimedia interface (HDMI) port (not shown), a component jack (not shown), a PC port (not shown), and a universal serial bus (USB) port (not shown). Also, the image input unit 210 may include a combination of a HDMI port, a component jack, a PC port, and a USB port. In this case, the image input unit 210 may directly receive video data to be reproduced by the display device 200, through an HDMI port, a component jack, a PC port, a USB port, or the like.

In addition, the display 220 visually outputs an image. For example, the display 220 may display an image corresponding to video data through a display panel (not shown) included therein such that the user may visually recognize the video content. In detail, the video data may include a plurality of frame images, and the display 220 may reproduce the video content by consecutively displaying the plurality of frame images under control by the processor 240.

The detector 230 includes at least one sensor.

In detail, the at least one sensor included in the detector 230 may obtain data used to identify a gesture of the user. In detail, the at least one sensor may include at least one of an image sensor, a motion sensor, and an infrared sensor.

For example, the image sensor may be a camera and may obtain an image of the user making a gesture. In detail, the detector 230 may include at least one camera to obtain an image of the user in order to detect a gesture of the user. For example, when the user watches the video content and follows movements shown in the video content, each of the at least one camera included in the detector 230 may capture an image of a gesture, a motion, a posture, or a form of the user corresponding to a movement of the user. Then, the processor 240 may identify the gesture of the user by analyzing the obtained image.

In detail, each of the at least one camera included in the detector 230 may be a two-dimensional camera that obtains a two-dimensional image, or a three-dimensional camera that obtains an image of an object including depth information of the object. Then, the display device 200 may detect the gesture of the user by using the at least one sensor included in the detector 230. In detail, the processor 240 may detect the gesture of the user, based on an image obtained from the at least one camera included in the detector 230.

In addition, although FIG. 2 describes and illustrates an example in which the detector 230 is included in the display device 200, the detector 230 may be implemented as a separate device physically distinct from the display device 200. In this case, the detector 230 may be electrically connected, directly or indirectly, to the display device 200, and the display device 200 may receive a result of detection by the detector 230 through a communication unit.

Referring back to FIG. 1, the detector 230 may include a camera 105 arranged on the front surface of the display device 100 or 200 to capture an image of the user 150. Hereinafter, an example in which the at least one sensor included in the detector 230 is a camera (e.g., 105 of FIG. 1) that obtains an image will be described. In addition, an image obtained by the camera may be an image showing a posture, a gesture, a motion, a pose, and/or a movement of the user. Hereinafter, for convenience of description, the terms ‘posture’, ‘gesture’, ‘motion’, ‘pose’, and/or ‘movement’ are collectively referred to as ‘gesture’.

The processor 240 executes at least one instruction to perform control such that an intended operation is performed. Also, the processor 240 may control the overall operation of the display device 200. In addition, the processor 240 may control other components included in the display device 200 to perform a certain operation.

In detail, the processor 240 may include an internal memory (not shown) and at least one processor (not shown) configured to execute at least one stored program. Here, the internal memory (not shown) of the processor 240 may store one or more instructions. Also, the processor 240 may execute at least one of the one or more instructions stored in the internal memory (not shown) to perform a certain operation.

In detail, the processor 240 may include random-access memory (RAM) (not shown), which stores signals or data input from the outside of the display device 200 or is used as a storage for various operations performed by the display device 200, read-only memory (ROM) (not shown) storing a control program for controlling the display device 200 and/or a plurality of instructions, and at least one processor (not shown).

Also, the processor 240 may include a graphics processing unit (GPU) (not shown) for graphics processing on a video. The processor 240 may be implemented as a system-on-chip (SoC) in which a core (not shown) and a GPU (not shown) are integrated. In addition, the processor 240 may include a single processor core (single-core) or a plurality of processor cores (multi-core). For example, the processor 240 may be dual-core, triple-core, quad-core, hexa-core, octa-core, deca-core, dodeca-core, hexadecimal-core, or the like.

In addition, the processor 240 may receive at least one of a plurality of images (e.g., frame images) included in video content obtained by the image input unit 210, and analyze and/or process the at least one image. Also, the processor 240 may receive an image showing a gesture of the user obtained by the detector 230, and analyze and/or process the received image.

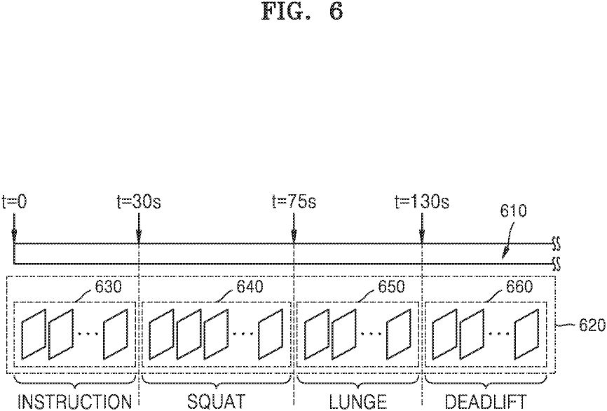

Detailed operations of embodiments of the present disclosure will be described in detail below with reference to FIGS. 6 to 16.

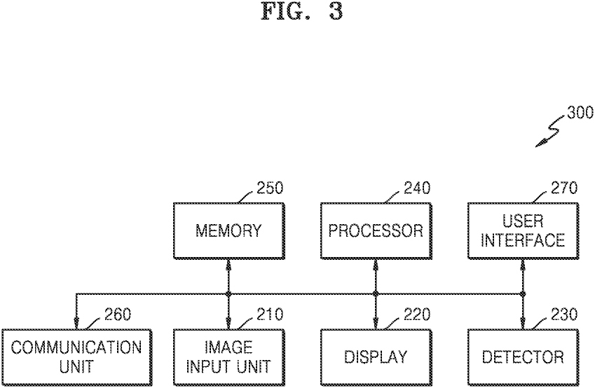

FIG. 3 is another block diagram illustrating a display device according to an example embodiment.

A display device 300 illustrated in FIG. 3 may correspond to the display device 200 illustrated in FIG. 2. Thus, in describing the display device 300, the descriptions provided above with reference to FIG. 2 will be omitted.

Referring to FIG. 3, the display device 300 may further include at least one of a memory 250, a communication unit 260 comprising communication circuitry, and a user interface 270, in addition to the components of the display device 300 illustrated in FIG. 2.

The memory 250 may store at least one instruction. In addition, the memory 250 may store at least one instruction executable by the processor 240. In addition, the memory 250 may store at least one program executable by the processor 240. In addition, the memory 250 may store information or data used for the operation of the display device 300. In addition, the memory 250 may store video content reproducible by the display device 300.

In detail, the memory 250 may include at least one of a flash memory-type storage medium, a hard disk-type storage medium, a multimedia card micro-type storage medium, a card-type memory (e.g., SD or XD memory), RAM, static RAM (SRAM), ROM, electrically erasable programmable ROM (EEPROM), programmable ROM (PROM), magnetic memory, a magnetic disk, and an optical disc.

The communication unit 260 communicates with an external device (not shown) through at least one wired or wireless communication network. In an example embodiment, the communication unit 260 may communicate with an external device (not shown). Here, the external device may be a server, and the communication unit 260 may communicate with a server (not shown). Here, the server (not shown) may be a content providing server that provides video content, an Internet server, or the like. Alternatively, the server (not shown) may be a server that analyzes or processes an image.

In detail, the communication unit 260 may include at least one communication module, a communication circuit, and the like, and may transmit and receive data to and from an external device through the communication module and/or the communication circuit.

In detail, the communication unit 260 may include at least one short-range communication module (not shown) configured to perform communication according to a communication standard such as Bluetooth, Wi-Fi, Bluetooth Low Energy (BLE), near-field communication (NFC)/radio frequency identification (RFID), Wi-Fi Direct, ultra-wideband (UWB), or Zigbee.

In addition, the communication unit 260 may further include a long-range communication module (not shown) configured to perform communication with a server (not shown) for supporting long-range communication according to a long-range communication standard. In detail, the communication unit 260 may include a long-range communication module (not shown) configured to perform communication through a network for Internet communication. Also, the communication unit 260 may include a communication network conforming to a communication standard, such as 3^{rd} Generation (3G), 4^{th} Generation (4G), 5^{th} Generation (5G), and/or 6^{th} Generation (6G).

In addition, the communication unit 260 may include a short-range communication module capable of receiving a control command from a remote controller (not shown), for example, an infrared (IR) communication module. In this case, the communication unit 260 may receive a control command from the remote controller (not shown). For example, the control command received from the remote controller (not shown) may include a turn-on or turn-off command or the like.

As described above, the communication unit 260 may perform some of functions of the image input unit 210 described above with reference to FIG. 2. For example, among the data obtaining functions of the image input unit 210 described above with reference to FIG. 2, the communication unit 260 may obtain video content by receiving data corresponding to the video content through a wired/wireless communication network.

The user interface 270 may receive a user input for controlling the display device 300. The user interface 270 may include a user input device including a touch panel for detecting a touch of the user, a button for receiving a push operation of the user, a wheel for receiving a rotation operations of the user, a keyboard, a dome switch, and the like, but is not limited thereto.

In addition, the user interface 270 may include a speech recognition device (not shown) for speech recognition. For example, the speech recognition device may be a microphone, and may receive a voice command or a voice request of a user. Accordingly, the processor 240 may control an operation corresponding to the voice command or voice request to be performed.

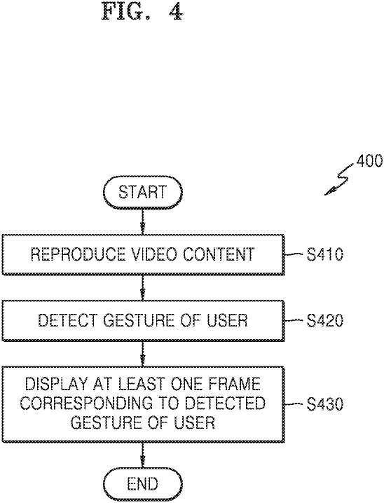

Also, the user interface 270 may include a motion sensor (not shown). For example, the motion sensor (not shown) may detect a motion of the display device 300 and receive the detected motion as a user input. Also, the speech recognition device (not shown) and the motion sensor (not shown) may not be included in the user interface 270, but may be included in the display device 300 as the detector 230 described above with reference to FIG. 1, which is a module independent from the user interface 270. FIG. 4 is a flowchart illustrating an operation method of a display device according to an example embodiment. In detail, an operation method 400 of a display device illustrated in FIG. 4 may be an operation method of the display device 100, 200, or 300 according to an example embodiment described above with reference to FIGS. 1 to 3. That is, FIG. 4 may be a flowchart illustrating operations of the display device 100, 200, or 300 according to an example embodiment. Thus, in describing operations included in the operation method 400 of the display device, the descriptions of the operations performed by the display device 100, 200, or 300 provided above with reference to FIGS. 1 to 3 will be omitted.

Hereinafter, an example will be described in which the operation method 400 of the display device is performed by the display device 200 of FIG. 2.

Referring to FIG. 4, the operation method 400 of the display device includes reproducing video content through the display 220 (S410). Operation S410 may be performed through the display 220 under control by the processor 240. In detail, the video content obtained by the image input unit 210 may be reproduced on the display 220 under control by the processor 240.

In addition, the operation method 400 of the display device further includes detecting a gesture of a user while the video content is reproduced, based on a result of detection by at least one sensor (S420). Operation S420 may be performed by the processor 240. In detail, the processor 240 may receive the result of the detection by the at least one sensor included in the detector 230, and identify the gesture of the user based on the received result.

The operation method 400 of the display device further includes controlling the reproduction of the video content such that at least one frame corresponding to the detected gesture among a plurality of frames included in the video content is displayed on the display 220 (S430). In detail, the operation method 400 of the display device further includes outputting, through the display 220, the at least one frame corresponding to the gesture detected in operation S420, among the plurality of frames included in the video content (S430). Operation S430 may be performed through the display 220 under control by the processor 240.

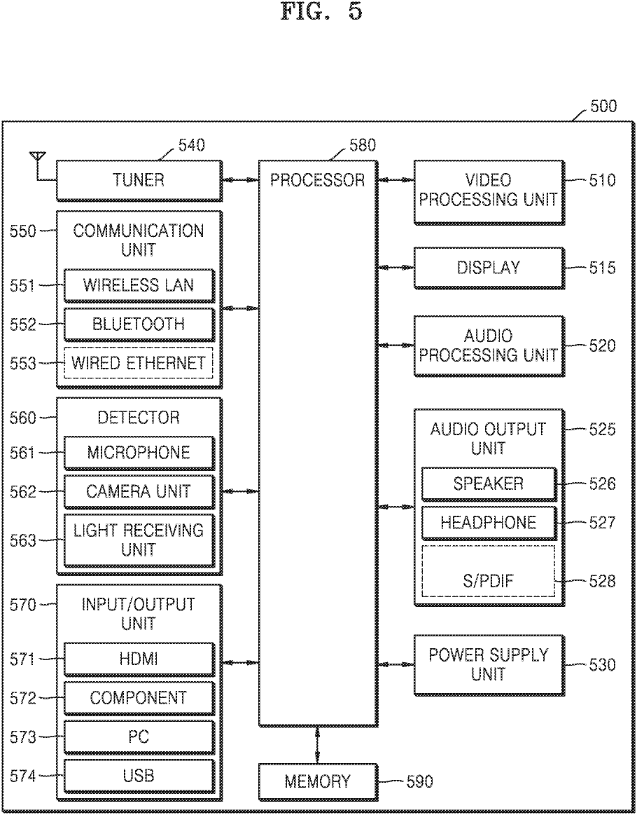

FIG. 5 is another block diagram illustrating a display device according to an example embodiment. A display device 500 illustrated in FIG. 5 may correspond to the electronic device 100, 200, or 300 illustrated in FIGS. 1 to 3. Thus, in describing the display device 500, the descriptions provided above with reference to FIGS. 1, 2, and 3 will be omitted.

An electronic device according to an example embodiment may be a display device, and FIG. 5 is a block diagram illustrating in detail the display device 500, which is the electronic device according to an example embodiment.

Referring to FIG. 3, the display device 500 includes a video processing unit 510, a display 515, an audio processing unit 520, an audio output unit 525, a power supply unit 530, a tuner 540, a communication unit 550, a detector (560), an input/output unit 570, a processor 580, and a memory 590.

Here, the processor 580 may correspond to the processor 240 illustrated in FIGS. 2 and 3. The communication unit 550, the display 515, the detector 560, and the memory 590 of the display device 500 may correspond to the communication unit 260, the display 220, the detector 230, and the memory 250 illustrated in FIG. 3, respectively. In addition, the communication unit 550 and the input/output unit 570 may correspond to the image input unit 210 illustrated in FIGS. 2 and 3. Thus, in describing the display device 500, the descriptions provided above with reference to FIGS. 2 and 3 will be omitted. The video processing unit 510 processes video data received by the display device 500. The video processing unit 510 may perform various image processing operations, such as decoding, scaling, noise filtering, frame rate conversion, or resolution conversion, on the video data.

The display 515 may display, on a screen, a video included in a broadcast signal received through the tuner 540, under control by the processor 580. Also, the display 515 may display content (e.g., a video) input through the communication unit 550 or the input/output unit 570.

Also, the display 515 may output an image stored in the memory 590, under control by the processor 580. In addition, the display 515 may display a voice user interface (UI) (e.g., including a voice instruction guide) for performing a voice-recognized task corresponding to a recognized voice, or a motion UI (e.g., including a user motion guide for motion recognition) for performing a motion-recognized task corresponding to a recognized motion.

In an example embodiment, the display 515 may reproduce video content including a material showing a movement.

The audio processing unit 520 processes audio data. The audio processing unit 520 may perform various processing operations, such as decoding, amplification, or noise filtering, on the audio data. In addition, the audio processing unit 520 may include a plurality of audio processing modules to process an audio corresponding to a plurality of pieces of content.

The audio output unit 525 outputs an audio included in a broadcast signal received through the tuner 540 under control by the processor 580. The audio output unit 525 may output an audio (e.g., a voice or a sound) input through the communication unit 550 or the input/output unit 570. Also, the audio output unit 525 may output an audio stored in the memory 590 under control by the processor 580. The audio output unit 525 may include at least one of a speaker 526, a headphone output port 527, and a Sony/Philips Digital Interface (S/PDIF) output port 528. The audio output unit 525 may include a combination of the speaker 526, the headphone output port 527, and the S/PDIF output port 528.

The power supply unit 530 supplies power input from an external power source, to the components 510 to 590 inside the display device 500 under control by the processor 580. In addition, the power supply unit 530 may supply power output from one or more batteries (not shown) in the display device 500, to the internal components 510 to 590, under control by the processor 580.

The tuner 540 may be tuned to and select only a frequency of a channel desired to be received by the display device 500 from among a number of radio wave components by performing amplification, mixing, resonance, or the like on a broadcast signal received in a wired or wireless manner. The broadcast signal includes an audio, a video, and additional information (e.g., an electronic program guide (EPG)).

The tuner 540 may receive a broadcast signal at a frequency band corresponding to a channel number (e.g., a cable broadcast channel No. 506), based on a user input (e.g., a control signal such as an input of a channel number, an input of channel up-down, or an input of a channel on an EPG screen, which is received from an external controller, such as a remote controller).

The tuner 540 may receive a broadcast signal from various sources, such as terrestrial, cable, satellite, and Internet broadcasters. The tuner 540 may also receive a broadcast signal from a source such as an analog or digital broadcaster. The broadcast signal received through the tuner 540 may be decoded (e.g., audio-decoded, video-decoded, or additional-information-decoded) and separated into an audio, a video, and/or additional information. The audio, video, and/or additional information may be stored in the memory 590 under control by the processor 580.

The display device 500 may include one or more tuners 540. According to an embodiment, in a case in which a plurality of tuners 540 are included in the display device 500, a plurality of broadcast signals may be output on a plurality of windows included in a multi-window screen provided on the display 515.

The tuner 540 may be integrated with the display device 500 in the form of an all-in-one device, or be implemented as a separate device having a tuner electrically connected, directly or indirectly, to the display device 500 (e.g., a set-top box (STB) (not shown) or a tuner (not shown) connected, directly or indirectly, to the input/output unit 570).

The communication unit 550 may connect the display device 500 to an external device (e.g., an audio device) under control by the processor 580. The processor 580 may transmit and receive content to and from an external device connected thereto, download an application from the external device, or perform web browsing, through the communication unit 550. In detail, the communication unit 550 may access a network to receive content from an external device (not shown).

As described above, the communication unit 550 may include at least one of a short-range communication module (not shown), a wired communication module (not shown), and a mobile communication module (not shown).

FIG. 5 illustrates an example in which the communication unit 550 includes one of a WLAN 551, a Bluetooth communication unit 552, and a wired Ethernet unit 553.

Also, the communication unit 550 may include a module combination including one or more of the WLAN 551, the Bluetooth communication unit 552, and the wired Ethernet unit 553. In addition, the communication unit 550 may receive a control signal from a control device (not shown) under control by the processor 580. The control signal may be implemented as a Bluetooth type, a radio frequency (RF) signal type, or a Wi-Fi type.

The communication unit 550 may further include an NFC module (not shown) or a separate BLE module (not shown), in addition to a Bluetooth module.

The detector 560 detects a voice of the user, an image of the user, or an interaction of the user.

In an example embodiment, the detector 560 may obtain data for identifying a gesture of the user. In detail, the detector 560 may include a camera unit 562, and may obtain data for identifying a gesture of the user (e.g., an image showing a gesture of the user), by using the camera unit 562.

The detector 560 may include the camera unit 562. In addition, the detector 560 660 may further include at least one of a microphone 561 and a light receiving unit 563.

The microphone 561 receives a voice uttered by the user. The microphone 561 may convert the received voice into an electrical signal and output the electrical signal to the processor 580. The voice of the user may include, for example, a voice corresponding to a menu or a function of the display device 500. For example, the recommended recognition range of the microphone 561 is a distance of 4 m from the microphone 561 to the location of the user, and may vary depending on the loudness of the voice of the user and an ambient environment (e.g., a speaker sound or ambient noise).

The microphone 561 may be integrated with or separated from the display device 500. When separated, the microphone 561 may be electrically connected to the display device 500 through the communication unit 550 or the input/output unit 570.

It will be understood by those of skill in the art that the microphone 561 may be excluded depending on the performance and structure of the display device 500.

The camera unit 562 receives an image (e.g., consecutive frames) corresponding to a motion of the user, including a gesture, in the recognition range of a camera. For example, the recognition range of the camera unit 562 may be within a distance of 0.1 m to 5 m between the camera unit 562 and the user. The motion of the user may include, for example, a gesture or a motion of a body part of the user, such as the face, a facial expression, a hand, a fist, or a finger. The camera unit 562 may convert the received image into an electrical signal and output the electrical signal to the processor 580, under control by the processor 580.

The processor 580 may select a menu to be displayed on the display device 500 or perform a control operation based on a result of recognizing the received motion. For example, channel adjustment, volume adjustment, and indicator movement may be included.

The camera unit 562 may include a lens (not shown) and an image sensor (not shown). The camera unit 562 may support optical zoom or digital zoom by using a plurality of lenses and image processing. The recognition range of the camera unit 562 may be variously set according to the angle of the camera and an ambient environment condition. In a case in which the camera unit 562 includes a plurality of cameras, a three-dimensional still image or a three-dimensional motion may be received by using the plurality of cameras.

The camera unit 562 may be integrated with or separate from the display device 500. A separate device (not shown) including the separate camera unit 562 may be electrically connected to the display device 500 through the communication unit 550 or the input/output unit 570.

It will be understood by those of skill in the art that the camera unit 562 may be excluded depending on the performance and structure of the display device 500.

The light receiving unit 563 receives an optical signal (including a control signal) from an external control device (not shown) through an optical window (not shown) of a bezel of the display 515. The light receiving unit 563 may receive, from a control device (not shown), an optical signal corresponding to a user input (e.g., a touch, a push, a touch gesture, a voice, or a motion). A control signal may be extracted from the received optical signal, under control by the processor 580.

For example, the light receiving unit 563 may receive a signal corresponding to a pointing position of the control device (not shown) and transmit the signal to the processor 580. For example, in a case in which a UI screen for receiving data or a command from the user is displayed on the display 515 and the user intends to input data or a command to the display device 500 through the control device (not shown), and thus moves the control device (not shown) while touching a finger on a touch pad (not shown) provided on the control device (not shown), the light receiving unit 563 may receive a signal corresponding to the motion of the control device (not shown), and transmit the signal to the processor 580. In addition, the light receiving unit 563 may receive a signal indicating that a particular button provided on the control device (not shown) is pressed, and transmit the signal to the processor 580. For example, when the user presses, with a finger, a button-type touch pad (not shown) provided on the control device (not shown), the light receiving unit 563 may receive a signal indicating that the button-type touch pad is pressed, and transmit the signal to the processor 580. For example, the signal indicating that the button-type touch pad is pressed may be used as a signal for selecting one of items.

The input/output unit 570 receives a video (e.g., a moving image), an audio (e.g., a voice or music), and additional information (e.g., an EPG) from the outside of the display device 500, under control by the processor 580. The input/output unit 570 may include one of an HDMI port 571, a component jack 572, a PC port 573, and a USB port 574. The input/output unit 570 may include a combination of the HDMI port 571, the component jack 572, the PC port 573, and the USB port 574.

It will be understood by those of skill in the art that the configuration and operation of the input/output unit 570 may be implemented in various ways according to an example embodiment.

The processor 580 controls the overall operation of the display device 500 and signal flows between internal components (not shown) of the display device 500, and processes data. When a user input is received or a preset and stored condition is satisfied, the processor 580 may execute an operating system (OS) and various applications stored in the memory 590.

The processor 580 may include RAM (not shown) storing signals or data input from the outside of the display device 500 or used as a storage area for various operations performed by the display device 500, ROM (not shown) storing a control program for controlling the display device 500, and a processor (not shown).

The processor (not shown) may include a GPU (not shown) for graphics processing on a video. The processor (not shown) may be implemented as an SoC in which a core (not shown) and the GPU (not shown) are integrated. The processor (not shown) may include a single core, dual cores, triple cores, quad cores, or cores corresponding to a multiple thereof.

The processor (not shown) may include a plurality of processors. For example, the processor (not shown) may be implemented as a main processor (not shown) and a sub-processor (not shown) operating in a sleep mode.

The GPU (not shown) may generate a screen including various objects, such as an icon, an image, or a text, by using a calculation unit (not shown) and a rendering unit (not shown). The calculation unit may calculate attribute values, such as coordinates, a shape, a size, or a color of each object to be displayed, based on a screen layout by using a user interaction detected by a sensor unit (not shown). The rendering unit generates a screen of various layouts including objects, based on the attribute values calculated by the calculation unit. The screen generated by the rendering unit is displayed in a display area of the display 515.

Hereinafter, video content reproduced by the display device 100, 200, 300 or 500 according to an example embodiment will be described in detail with reference to FIGS. 6 to 10. In addition, an example in which video content is reproduced by the display device 200 described above with reference to FIG. 2 will be described with reference to FIGS. 6 to 10.

FIG. 6 is a diagram for describing video content reproduced by a display device according to an example embodiment.

In an example embodiment, the video content may include a plurality of frames 620 corresponding to a plurality of images, respectively. In addition, the video content may be content including a material showing movements.

The drawings including FIG. 6 to be described below illustrate an example in which the video content reproduced in an example embodiment is home training lesson content including at least one strength training movement.

Referring to a time table 610 representing the video content in FIG. 6, a period between the video start time point t = 0 (seconds) and t = 30 may include a lesson instruction, a period between t = 30 and t = 75 may include a lesson on a squat movement, a period between t = 75 and t = 130 may include a lesson on a lunge movement, and a period between t = 130 and t = 200 may include a lesson on a deadlift movement.

In addition, the plurality of frames 620 included in the video content may have a certain frame rate. For example, the video content may be reproduced at 30, 60, or 120 frames per second.

In addition, at least one frame may be included in each movement shown in the video content. For example, the period between t = 0 to t = 30 may include a plurality of frames 630 corresponding to the lesson instruction, and the period between t = 30 to t = 75 may include a plurality of frames 640 corresponding to the lesson on the squat movement. In addition, the period between t = 75 and t = 130 may include a plurality of frames 650 corresponding to the lesson on the lunge movement, and the period between t = 130 and t = 200 may include a plurality of frames 660 corresponding to the lesson on the deadlift movement.

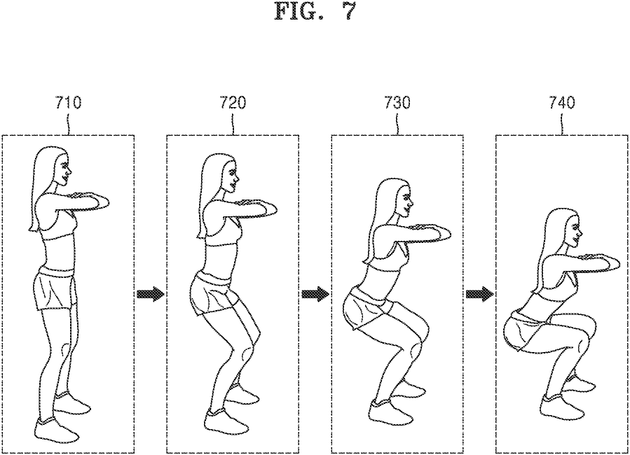

FIG. 7 is a diagram for describing images output on a screen according to reproduction of video content. In detail, FIG. 7 is a diagram for describing a squat lesson included in the video content described above with reference to FIG. 6. Thus, in describing the movement illustrated in FIG. 7, FIG. 6 will be referred to together.

Referring to FIG. 7, the plurality of frames 640 corresponding to the squat lesson may be image frames for showing a squat movement. In detail, the plurality of frames 640 may include a plurality of image frames showing changes in gestures (or motions) according to the squat movement.

In detail, the squat movement may be performed by continuously taking postures for a first gesture 710, a second gesture 720, a third gesture 730, and a fourth gesture 740. Here, at least one frame may correspond to each of the first gesture 710, the second gesture 720, the third gesture 730, and the fourth gesture 740.

When a display device (e.g., 200) reproduces the plurality of frames 640 corresponding to the squat lesson, the user may watch the reproduced frames 640 and follow the squat movement in real time.

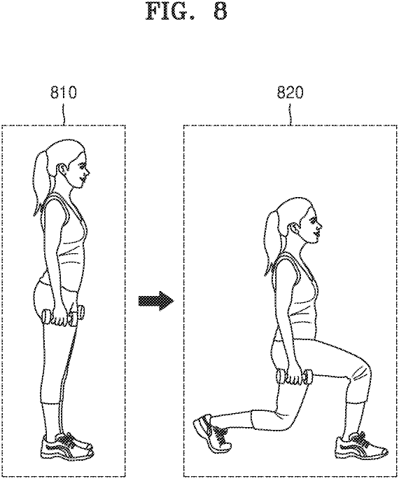

FIG. 8 is another diagram for describing images output on a screen according to reproduction of video content. In detail, FIG. 8 is a diagram for describing a lunge lesson included in the video content described above with reference to FIG. 6. Thus, in describing the movement illustrated in FIG. 8, FIG. 6 will be referred to together.

In detail, the plurality of frames 650 may include a plurality of image frames showing changes in gestures (or motions) according to the lunge movement.

In detail, the lunge movement may be performed by continuously taking postures for a first gesture 810 and a second gesture 820. Here, at least one frame may correspond to each of the first gesture 810 and the second gesture 820.

When a display device (e.g., 200) reproduces the plurality of frames 650 corresponding to the lunge lesson, the user may watch the reproduced frames 650 and follow the lunge movement in real time.

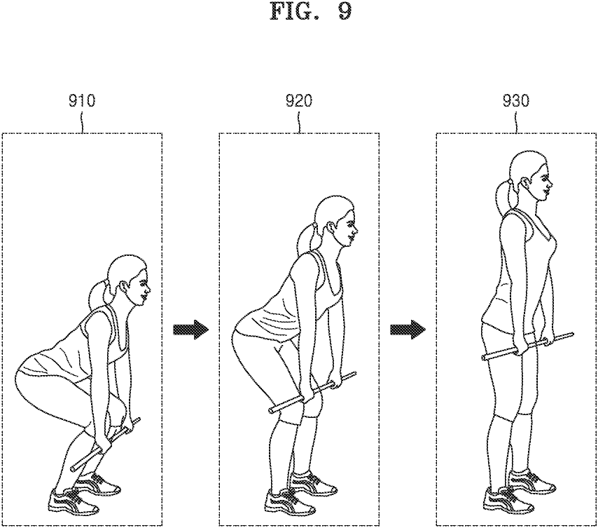

FIG. 9 is another diagram for describing images output on a screen according to reproduction of video content. In detail, FIG. 9 is a diagram for describing a deadlift lesson included in the video content described above with reference to FIG. 6. Thus, in describing the movement illustrated in FIG. 9, FIG. 6 will be referred to together.

In detail, the plurality of frames 660 may include a plurality of image frames showing changes in gestures (or motions) according to the deadlift movement.

In detail, the deadlift movement may be performed by continuously taking postures for a first gesture 910, a second gesture 920, and a third gesture 930. Here, at least one frame may correspond to each of the first gesture 910, the second gesture 920, and the third gesture 930.

When a display device (e.g., 200) reproduces the plurality of frames 660 corresponding to the deadlift lesson, the user may watch the reproduced frames 660 and follow the deadlift movement in real time.

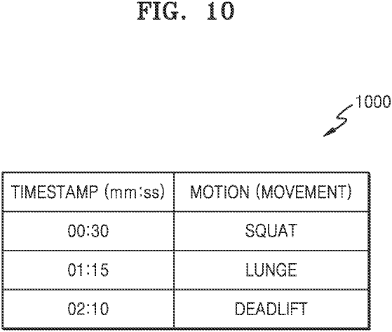

FIG. 10 is a diagram illustrating movements shown in video content reproduced during respective time periods.

FIG. 10 illustrates a time table 1000 corresponding to the video content described above with reference to FIGS. 6 to 9.

In an example embodiment, the processor 240 may identify a plurality of different movements included in the video content. In the above example, the processor 240 may receive the video content obtained by the image input unit 210 and distinguish or identify the plurality of movements in the video content. In addition, the processor 240 may obtain information about the plurality of distinguished movements.

For example, in a case in which the video content is transmitted or stored in non-real time, the video content may be stored in the memory 250 included in the display device (e.g., 300), and the processor 240 may read and analyze the video content that has been transmitted or stored.

In addition, in a case in which the video content is transmitted in real time, the processor 240 may analyze in real time a stream corresponding to the video content being transmitted in real time, and obtain reproduction time information for each of the movements included therein, prior to reproduction of the video content.

For example, in a case in which the video content is a live video or live content, the processor 240 may store a received stream in real time. In detail, the processor 240 may store the stream in an internal memory of the processor 240, or may store the stream in the memory 250 included in the display device (e.g., 300). In addition, the processor 240 may analyze the stored stream to analyze movements included in the video content, and identify a plurality of movements. Also, the processor 240 may obtain reproduction time information for each of the identified movements.

In addition, the processor 240 may pre-store information about representative movements or representative postures for each exercise, home training, and dance in order to distinguish or identify the plurality of movements included in the video content. Also, the processor 240 may identify the plurality of movements included in the video content by using the stored representative movements or representative postures.

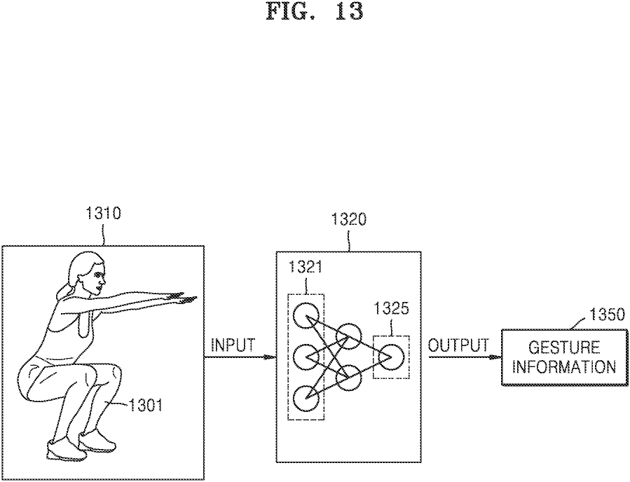

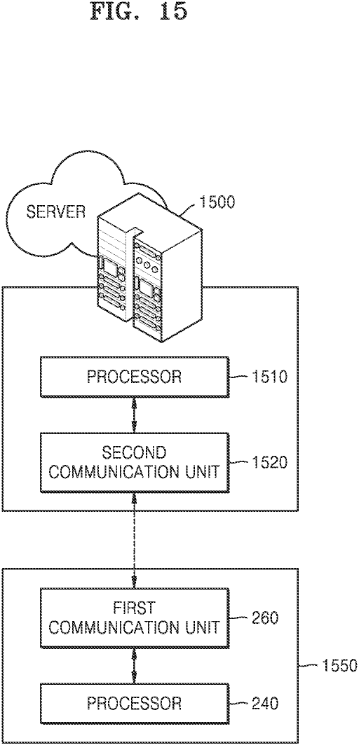

Alternatively, the processor 240 may use a neural network based on machine learning or artificial intelligence (AI) to distinguish or identify the plurality of movements included in the video content. Distinguishment between movements through the neural network will be described in detail below with reference to FIGS. 13 and 15.

In detail, the processor 240 may analyze the video content to identify a plurality of different movements included in the video content and obtain information about reproduction time of the identified plurality of movements. In addition, the processor 240 may perform control, based on the obtained information about the reproduction time, such that at least one frame corresponding to a detected gesture among a plurality of frames included in the video content is displayed through the display 220.

Here, the information about the reproduction time may include at least one of a reproduction start time point for each movement, a reproduction end time point for each movement, a reproduction time period for each movement, and reproduction section information for each movement. Hereinafter, for convenience of description, ‘information about reproduction time’ will be referred to as ‘reproduction time information’.

In detail, the processor 240 may obtain the time table 1000 illustrated in FIG. 10 by analyzing the video content. For example, the processor 240 may identify a plurality of movements included in the video content through image analysis, and obtain reproduction time information of frames corresponding to the plurality of movements.

Alternatively, additional data or meta data included in the video content may include the reproduction time information about the included movements. For example, the video content may include information about a reproduction time point at which a squat movement starts, and a reproduction time point at which a lunge movement starts. In this case, the processor 240 may extract the additional data or the meta data included in the video content and obtain reproduction time information of the frames corresponding to the plurality of movements, based on the extracted additional data or meta data.

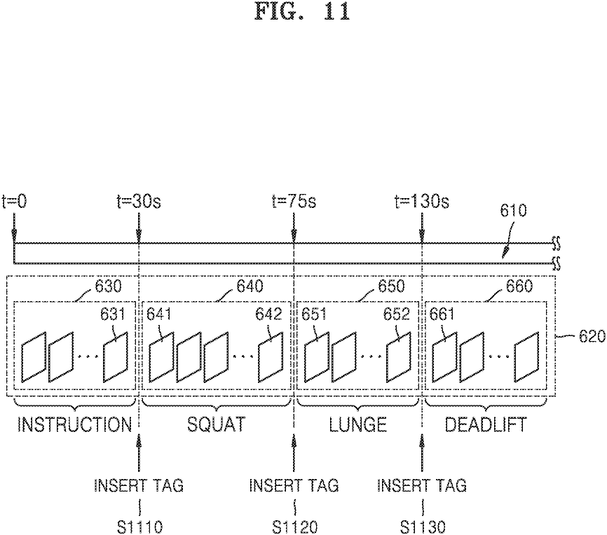

FIG. 11 is a diagram for describing tags of video content used in an example embodiment. In FIG. 11, the same elements as those of FIG. 6 are illustrated by using the same reference numerals, and thus redundant descriptions will be omitted.

In an example embodiment, the processor 240 may analyze the video content to identify a plurality of different movements included in the video content. Also, the processor 240 may generate tagged video content by inserting, into the video content, at least one tag corresponding to the plurality of identified movements, respectively. The tagged video content may be stored in the display device 200.

Here, the tag refers to information inserted or added into the video content to identify the plurality of movements included in the video content, and may be referred to as, for example, a flag.

Referring to FIG. 11, the processor 240 may insert tags at boundaries between different movements within the plurality of frames 620 included in the video content. In detail, a tag may be inserted between the frames 630 corresponding to the lesson instruction and the frames 640 corresponding to the squat movement (S1110). In addition, the tag may include information indicating the identified movement. For example, the tag inserted in S1110 may include information indicating the ‘squat’ movement.

Also, a tag may be inserted between the frames 640 corresponding to the squat movement and the frames 650 corresponding to the lunge movement (S1120). In addition, the tag may include information indicating the identified movement. For example, the tag inserted in S1120 may include information indicating the ‘lunge’ movement.

Also, a tag may be inserted between the frames 650 corresponding to the lunge movement and the frames 660 corresponding to the deadlift movement (S1130). In addition, the tag may include information indicating the identified movement. For example, the tag inserted in S1130 may include information indicating the ‘deadlift’ movement.

As another example, for each identified movement, a tag may be added or inserted into at least one of the first frame and the last frame of at least one frame corresponding to the movement. For example, a tag indicating the squat movement may be inserted into at least one of a first frame 641 and a last frame 642 of the plurality of frames 640 corresponding to the squat movement. In addition, a tag indicating the lunge movement may be inserted into at least one of a first frame 651 and a last frame 652 of the plurality of frames 650 corresponding to the lunge movement. In addition, a tag indicating the deadlift movement may be inserted into at least one of a first frame 661 and a last frame 662 of the plurality of frames 660 corresponding to the deadlift movement.

Also, the processor 240 may store tag information including a table (or a list) including at least one generated tag. The tag information may be stored in an internal memory of the processor 240 or a separate memory (e.g., 250 of FIG. 3) included in the display device (e.g., 200 or 300).

Alternatively, when creating the video content, the creator of the video content may create the video content by adding tags identifying the plurality of movements. For example, in a case in which a table of contents or thumbnail images indicating parts included in the content is displayed in a time bar or a progress bar indicating the reproduction time of the video content, it may be said that the video content includes tags. In this case, the processor 240 may retrieve the tags included in the video content and identify the plurality of movements based on the retrieve tags.

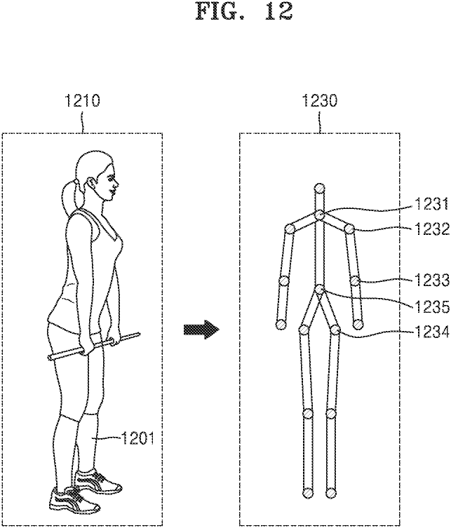

Hereinafter, the detecting of the user gesture in operation S420 will be described in detail with reference to FIGS. 12 and 13. In addition, an example in which a result of detection by the detector 230 is at least one image showing a posture of the user will be illustrated and described with reference to FIGS. 12 and 13.

FIG. 12 is a diagram for describing an operation of detecting a gesture in an example embodiment.

Referring to FIG. 12, the processor 240 may identify a gesture of a user 1201 based on a result of detection by the detector 230. Here, the result of the detection by the detector 230 may be at least one continuously captured frame.

In detail, a frame (e.g., 1210) obtained by the detector 230 may be an image captured while the user 1201 follows a deadlift movement. In detail, when the user 1201 performs the deadlift movement, the detector 230 may continuously obtain a plurality of frames and transmit the plurality of obtained frames to the processor 240.

The processor 240 may analyze the plurality of frames obtained by the detector 230 to identify the gesture of the user. Identification of a gesture of the user may be performed by using various motion recognition techniques.

For example, the processor 240 may analyze the obtained frame 1210 to generate information 1230 indicating one or more feature points 1231, 1232, and 1233 for identifying the gesture of the user 1201, and identify movements of body parts, based on the feature points 1231, 1232, and 1233, thereby identify the gesture.

In the above example, the feature points 1231, 1232, and 1233 are reference points for distinguishing between motions or gestures of the user 1201, and may be set in various ways and with various frequencies for the respective body parts. For example, for a motion of a palm, each of the joints included in the palm may be set as a feature point. As another example, for the lower body including the pelvis, the feature point 1233 corresponding to a joint of a leg bone from the pelvis may be set. Then, the processor 240 may analyze movements of the body parts based on the feature points in each of the plurality of consecutively obtained frames to identify which posture the user is following, and which movement the gesture of the user corresponds to.

FIG. 13 is another diagram for describing an operation of detecting a gesture in an example embodiment. An operation of detecting a gesture will be described with reference to FIG. 13 and the display device 300 illustrated in FIG. 3.

In an example embodiment, a machine learning technique for motion detection may be used for the detecting of the gesture in operation S420.

In detail, for gesture detection, a motion recognition technique based on deep learning may be used. In detail, a method of recognizing a gesture by performing object recognition, object tracking, and object discrimination by using AI technology for performing computation through a neural network has been developed and used. Hereinafter, for convenience of description, operations for detecting a gesture by analyzing an image and perform object recognition, object tracking, and object discrimination will be collectively referred to as ‘gesture detection operations’.

The AI technology may be implemented by using algorithms. Here, an algorithm or a set of algorithms for implementing AI technology are called a neural network. Here, the neural network may receive an input of input data, perform computations for analysis and classification, and output resulting data. In order for the neural network to accurately output resulting data corresponding to input data, it is necessary to train the neural network. Here, the term ‘training’ may refer to training a neural network such that the neural network may discover or learn on its own a method of analyzing various pieces of data input to the neural network, a method of classifying the input pieces of data, and/or a method of extracting, from the input pieces of data, features necessary for generating resulting data. Here, ‘training’ may be expressed as ‘learning’ or ‘training’.

In addition, a set of algorithms for outputting output data corresponding to input data through the above-described neural network, software and/or hardware for executing the set of algorithms may be referred to as an ‘AI model’ (or an ‘artificial intelligence model’).

AI models may be in various forms. In detail, there may be various AI models that perform an operation of receiving an image, analyzing the input image, and classifying a gesture of an object included in the image into at least one class.

The AI model may include at least one neural network, and for convenience of description, FIG. 13 illustrates an example in which one neural network 1320 is generated as an AI model for performing the gesture detection operation.

The neural network may be a deep neural network (DNN) including a plurality of layers to perform multi-stage computations. Also, DNN computations may include convolutional neural network (CNN) computations and the like. In detail, a data recognition model for object recognition may be implemented through the neural network of the example, and the implemented recognition model may be trained by using training data. In addition, by using the trained data recognition model, input data, for example, images captured by a camera, may be analyzed or classified to recognize an object in each of the input images, and a gesture corresponding to the recognized object may be recognized and output as output data. In addition, CNNs refer to neural networks that perform an algorithm for analyzing an image to find a pattern, and may include various types of neural networks.

Referring to FIG. 13, the neural network 1320 may be a neural network trained to receive, through an input layer 1321, at least one image 1310 obtained by the detector 230, extract an object in the input image 1310, identify a gesture corresponding to the extracted object, and output the identified gesture through an output layer 1325. Information output from the output layer 1325 may be gesture information 1350 indicating a gesture corresponding to an identified movement.

In a case in which the neural network 1320 receives the image 1310 obtained by the detector 230 while a user 1301 is following the squat movement, the neural network 1320 may analyze the input image 1310 to output the gesture information 1350 indicating the ‘squat movement’.

The AI model including the neural network 1320 may be stored in the processor 240. Alternatively, the AI model including the neural network 1320 may be implemented as a separate processor (not shown) included in the display device (e.g., 300). Alternatively, the AI model including the neural network 1320 may be stored in a separate storage device (e.g., the memory 250) included in the display device 300. As in the above examples, in a case in which the AI model including the neural network 1320 is stored in the display device 300, the processor 240 of the display device 300 may detect a gesture of the user by inputting at least one image obtained by the detector 230 to the AI model including the neural network 1320.

Also, in an example embodiment, the processor 240 may use the AI model including the neural network 1320 to distinguish between the plurality of different movements included in the video content.

In detail, the neural network 1320 may sequentially receive, through the input layer 1321, the plurality of frames included in the video content, analyze the input frames, and output, through the output layer 1325, information for distinguishing between the plurality of movements included in the plurality of frames.

In addition, the AI model including the neural network 1320 may be included or stored in a device separate from the display device 300. For example, the AI model including the neural network 1320 may be stored in an external device (not shown) connected to the display device 300 through a wired or wireless communication network. In this case, the display device 300 may transmit at least one image of the user obtained by the detector 230, to an external device through the communication unit 260. Then, the external device (not shown) may receive the at least one image and obtain the gesture information 1350 by using an AI model included therein. The external device (not shown) may transmit the obtained gesture information 1350 to the communication unit 260 of the display device 300. Then, the communication unit 260 may receive the transmitted gesture information 1350 and deliver the movement information 1350 to the processor 240. Accordingly, the processor 240 may detect a user gesture based on the gesture information 1350.

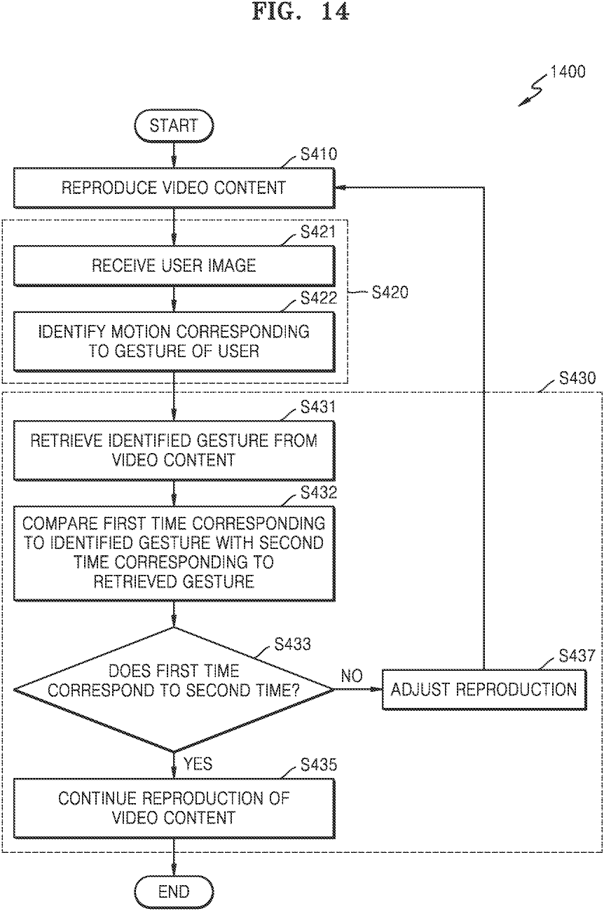

FIG. 14 is another flowchart illustrating an operation method of a display device according to an example embodiment. In detail, an operation method 1400 of a display device illustrated in FIG. 4 may be an operation method of the display device 100, 200, 300, or 500 according to an example embodiment described above with reference to FIGS. 1 to 5. That is, FIG. 14 may be a flowchart illustrating operations of the display device 100, 200, 300, or 500 according to an example embodiment. In addition, in FIG. 14, the same elements as those of FIG. 4 are illustrated by using the same reference numerals.

Thus, in describing operations included in the operation method 1400 of the display device, redundant descriptions will be omitted.

Referring to FIG. 14, the operation method 1400 of the display device includes reproducing video content through the display 220 (S410). Operation S410 may be performed through the display 220 under control by the processor 240.

In addition, the operation method 1400 of the display device further includes detecting a gesture of a user while the video content is reproduced, based on a result of detection by at least one sensor (S420). In detail, operation S420 may include operations S421 and S422.

In detail, the operation method 1400 of the display device may further include receiving a user image obtained by the at least one camera included in the detector 230 (S421). In detail, the processor 240 may receive the user image. Here, the user image refers to an image of the user following a movement shown in the video content, and may include the images 1210 and 1310 described above with reference to FIGS. 12 and 13.

In addition, the operation method 1400 of the display device may further include analyzing the user image received in operation S421 to identify a gesture corresponding to a movement currently being performed by the user (S422). Operation S422 may be performed by the processor 240. Alternatively, operation S422 may be performed by an external device (not shown) under control by the processor 240.

In detail, operation S422 may be performed by using the AI model described above with reference to FIG. 13. For example, in a case in which the processor 240 includes an AI model, operation S422 may be performed by the processor 240 itself. As another example, in a case in which the display device (e.g., 300) including the processor 240 does not include an AI model, operation S422 may be performed by the external device (not shown) described above with reference to FIG. 13. In this case, information about the identified gesture may be transmitted to the processor 240 through the communication unit 260.

The operation method 1400 of the display device may further include reproducing, through the display 220, at least one frame corresponding to the gesture detected in operation S420 among a plurality of frames included in the video content (S430).

Operation S430 may be performed through the display 220 under control by the processor 240.

In detail, the processor 240 may pause the reproduction of the video content, adjust the reproduction speed, or move the reproduction point of the video content, such that the at least one frame corresponding to the detected gesture among the plurality of frames included in the video content is displayed through the display 220.

In detail, the processor 240 may pause the reproduction of the video content such that the at least one frame corresponding to the detected gesture among the plurality of frames included in the video content is displayed through the display 220. For example, there may be cases in which the user cannot follow the progress speed of movements included in the video content being reproduced. In this case, the processor 240 may pause the reproduction of the video content until the user completes the movement being currently reproduced.

In addition, the processor 240 may adjust the reproduction speed of the video content such that the at least one frame corresponding to the detected gesture among the plurality of frames included in the video content is displayed through the display 220. For example, there may be cases in which the overall progress speed of the user following the movements included in the video content being reproduced is slow. In this case, the processor 240 may decrease the reproduction speed of the video content such that the movement currently shown in the video content being reproduced and the movement of the user are synchronized with each other. As another example, there may be cases in which the overall progress speed of the user following the movements included in the video content being reproduced is fast. In this case, the processor 240 may increase the reproduction speed of the video content such that the movement currently shown in the video content being reproduced and the movement of the user are synchronized with each other.

In addition, the processor 240 may change the part of the video content currently being reproduced, such that the at least one frame corresponding to the detected gesture among the plurality of frames included in the video content is displayed through the display 220. In detail, the processor 240 may move the reproduction point of the video content to at least one frame showing a movement or an action corresponding to the gesture of the user, such that the movement currently shown in the video content being reproduced and the movement of the user are synchronized with each other.

In detail, the operation method 1400 of the display device may further include, when the gesture of the user is identified, retrieving a movement included in the video content corresponding to the identified gesture (S431). Operation S431 may be performed based on at least one of the above-described reproduction time information and tag information.

For example, the processor 240 may analyze the video content to identify a plurality of different movements included in the video content and obtain information about reproduction time of the identified plurality of movements. In this case, the processor 240 may identify, based on the information about the reproduction time, at least one frame corresponding to the detected gesture among the plurality of frames included in the video content. In detail, as in the example illustrated in FIG. 12, in a case in which the gesture of the user is identified as corresponding to the lunge movement, the processor 240 may retrieve, based on reproduction time information on the lunge movement, a frame corresponding to the lunge movement, and control the reproduction of the video content such that the retrieved frame is displayed. In detail, referring to FIG. 6, because the reproduction time period corresponding to the lunge movement is the period between t = 75 and to t = 130, the processor 240 may retrieve the frames 650 that are within the reproduction time period, and control the reproduction of the video content such that the at least one frame corresponding to the gesture of the user is displayed.

In addition, the operation method 1400 of the display device may further include comparing a time corresponding to the identified gesture of the user (e.g., a first time) with the reproduction time included in the movement of the video content retrieved in operation S431 (e.g., a second time). Operation S431 may be performed based on at least one of the above-described reproduction time information and tag information.

For example, in the example illustrated in FIG. 13, in a case in which the gesture of the user is identified as a squat movement, the first time at which the corresponding gesture is detected may be compared with the second time corresponding to a reproduction time of a frame of the squat movement included in the video content corresponding to the detected gesture (S432).

Based on a result of the comparing in operation S432, it may be determined whether the time corresponding to the identified gesture of the user (e.g., the first time) corresponds to the reproduction time included in the movement of the video content retrieved in operation S431 (e.g., the second time) (S433).

Based on determining, in operation S433, that the first time corresponds to the second, it may be determined that the movement of the user and the movement shown in the video content being reproduced are synchronized with each other. Accordingly, the reproduction of the video content may be continued without requiring to adjust the reproduction of the video content (S435).

Based on determining, in operation S433, that the first time does not correspond to the second, it may be determined that the movement of the user and the movement shown in the video content being reproduced are not synchronized with each other. Accordingly, the reproduction of the video content may be adjusted (S437). The adjusting of the reproduction in operation S437 may be at least one of moving the reproduction point, pausing the reproduction, and adjusting the reproduction speed, which are described above.

For example, there may be a case in which the gesture of the user corresponds to the squat movement, but the video content currently being reproduced corresponds to the lunge movement. In this case, the processor 240 may move the reproduction point of the video content to the reproduction time point of the squat movement, based on at least one of the tag and reproduction time information such that the movement currently shown in the video content being reproduced matches the gesture of the user. Alternatively, the processor 240 may pause the reproduction of the video content, then wait until the user completes the squat movement and starts the lunge movement, such that the movement currently shown in the video content being reproduced matches the gesture of the user.

In addition, in an example embodiment, the processor 240 may obtain an image corresponding to the detected gesture, and perform control such that the obtained image is displayed to be superimposed on a reproduction screen of the video content.

In detail, the processor 240 may obtain a captured image corresponding to the detected gesture. Alternatively, the processor 240 may generate an avatar image corresponding to the detected gesture. Then, the obtained image may be included as a sub-screen of the reproduction screen. Then, the user may be able to recognize whether his or her posture is correct or incorrect, or whether the user is correctly following the movement, by checking the reproduction screen.

In addition, in an example embodiment, the processor 240 may perform control such that guide information about the detected gesture is displayed on the reproduction screen of the video content. For example, the guide information may include information for indicating which type of movement the detected gesture corresponds to, whether the user needs to follow the movement more quickly, how to move a part of the body, and the like.

FIG. 15 is a diagram for describing a server communicating with a display device according to an example embodiment. In FIG. 15, the same elements as those of FIGS. 2 and 3 are illustrated by using the same reference numerals. In addition, a display device 1550 illustrated in FIG. 15 may correspond to the display device 100, 200, 300, or 500 according to an example embodiment described above with reference to FIGS. 1 to 14. Thus, the descriptions provided above will be omitted.

In FIG. 15, for convenience of description, the communication unit 260 included in the display device 1550 is referred to as ‘first communication unit 260’, and a communication unit 1520 included in a server 1500, which is an external device, is referred to as ‘second communication unit 1520’.

The display device 1550 may communicate with an external device through a wired or wireless communication network. Here, the external device may be a separate electronic device (not shown) or the server 1500 that is physically distinct from the display device 1550. An example in which the external device is the server 1500 will be illustrated and described with reference to FIG. 15.

The display device 1550 is illustrated in FIG. 15 as including the processor 240 and the first communication unit 260, but may further include at least one of the components illustrated in FIGS. 3 and 5. However, such components are not illustrated for convenience of description.

Referring to FIG. 15, the server 1500 may include a processor 1510 and the second communication unit 1520. For example, the server 1500 may be a server that analyzes an image and performs computation through an AI model for performing at least one of recognizing an object and a gesture included in the image.

The processor 1510 may include an internal memory (not shown) and at least one processor (not shown) configured to execute at least one stored program. Here, the internal memory (not shown) of the processor 240 may store one or more instructions. Also, the processor 240 may execute at least one of the one or more instructions stored in the internal memory (not shown) to perform a certain operation. The internal configuration of the processor 1510 corresponds to that of the processor 240 described above with reference to FIG. 2, and thus, detailed descriptions thereof will be omitted.

In detail, the processor 1510 may include the AI model described above with reference to FIG. 13. In addition, the processor 1510 may perform, through the AI model, at least one of discrimination between different movements, object recognition, and gesture recognition.

The second communication unit 1520 communicates with the display device 1550 through at least one wired or wireless communication network. In detail, the second communication unit 1520 may include at least one communication module, a communication circuit, and the like, and may transmit and receive data to and from an external device through the communication module and/or the communication circuit. The internal configuration of the second communication unit 1520 corresponds to that of the communication unit 260 described above with reference to FIG. 3, and thus, detailed descriptions thereof will be omitted.

The display device 1550 may transmit a plurality of images obtained by photographing a posture, gesture, movement, or appearance of the user, through the first communication unit 260 to the second communication unit 1520 of the server 1500 in real time. Then, the processor 1510 of the server 1500 may identify the gesture of the user based on the received images, and transmit information about the identified gesture to the first communication unit 260 through the second communication unit 1520. “Based on” as used herein covers based at least on.

In addition, the display device 1550 may transmit video content to the second communication unit 1520 of the server 1500 in real time through the first communication unit 260. Then, the processor 1510 of the server 1500 may analyze the received video content by using the AI model to identify a plurality of movements, and obtain reproduction time information corresponding to the identified movements. Then, the processor 1510 may transmit the obtained information to the first communication unit 260 through the second communication unit 1520. Alternatively, the processor 1510 of the server 1500 may analyze the received video content by using the AI model to distinguish between the plurality of movements, and add tags corresponding to the distinguished movements to generate tagged video content. Then, the tagged video content may be transmitted to the first communication unit 260 through the second communication unit 1520.

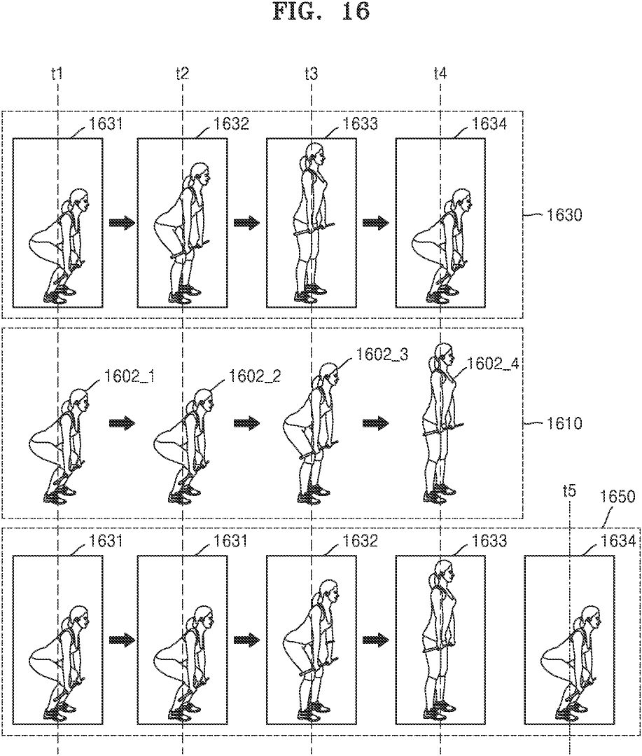

FIG. 16 is a diagram for describing an operation of adjusting reproduction of video content according to an example embodiment. In detail, FIG. 16 is a diagram for describing an operation, performed by the display device 100, 200, 300, or 500, of adjusting reproduction of video content, according to an example embodiment. The example described above with reference to FIGS. 6 to 10 in which the video content is reproduced by the display device 100, 200, 300, or 500 according to an example embodiment will be described with reference to FIG. 16.

Hereinafter, for convenience of description, an example will be described in which the operation of adjusting reproduction in FIG. 16 is performed by the display device 300 illustrated in FIG. 3.

Referring to FIG. 16, block 1630 represents the video content being reproduced on the display 220 before reproduction adjustment according to an example embodiment is performed. In addition, 1610 represents a state in which the user follows the video content reproduced on the display 220. In addition, block 1650 represents the video content being reproduced on the display 220 when the reproduction adjustment according to an example embodiment is performed. In addition, although FIG. 16 illustrates, for convenience of description, an example in which several frames are reproduced on the display 220, tens to hundreds of frames may represent the deadlift movement.

First, referring to block 1630, the display device 300 may sequentially reproduce, through the display 220, a plurality of frames 1631, 1632, 1633, and 1634 showing the deadlift movement, during time points t1 to t4.

In addition, at the time point t1, the user may watch a displayed image 1631 and follow the deadlift movement. The user may view the image 1631 and take a posture 1601_1, and as the video content is reproduced, the user may view a displayed image 1632 and follow the deadlift movement at the time point t2. As illustrated, the user is well following the movement shown in the reproduced video content until the time points t1 and t2. However, an image 1633 reproduced at the subsequent time point t3 corresponds to a standing posture in the deadlift movement, but at the time point t3, the user following the standing posture has not stood up, and is taking a posture 1602_3 that has been shown in the image displayed at the time point t2.

In this case, a general display device reproduces the video content regardless of whether the user is well following reproduced movements. Thus, the image 1633 reproduced at the time point t3 and the posture 1602_3 of the user following the movement at the same time point start to mismatch, and thus, a movement posture shown in the video content and the posture of the user are inevitably different from each other also at the time point t4. In this case, in the related art, the user has to manually pause the reproduction of the video content by using a separate control device or change his/her posture in the middle of following the posture.

Accordingly, it is impossible to reproduce and view the video content according to the user and an exercise state of the user.

In an example embodiment, the reproduction of the video content may be automatically adjusted without user intervention such that the gesture of the user is recognized and a frame corresponding to the recognized gesture is displayed. Accordingly, the user satisfaction may be improved by providing the reproduction speed or reproduction state of the video content optimized according to an exercise state or an intention of the user.

In detail, referring to block 1650, the processor 240 may retrieve at least one frame synchronized with the gesture of the user detected in real time at the time point t3, and may perform control such that the retrieved at least one frame 1632 is displayed on the display 220 at the time point t3. For reference, the time point t3 at which the gesture of the user is detected and the time point at which the frame 1632 corresponding to the detected gesture is displayed are both illustrated as the same time point t3, but there may be a time interval during which an operation of detecting the gesture of the user and an operation of retrieving the frame corresponding to the detected gesture are performed.

However, such a time interval may be minimized or reduced through fast computation through an AI model, and may be within a range that the user does not actually recognize as a time delay.

Thus, in an example embodiment, control may be performed such that movements synchronized with the movement of the user according to the gesture of the user are displayed. That is, when a gesture 1602_4 of the user is detected at a time point t4, the reproduction of the video content may be controlled such that the frame 1633 corresponding to the gesture 1602_4 detected at the time point t4 is displayed. Accordingly, the display 220 of the display device 300 may display the frame 1633 corresponding to the gesture 1602_4 detected at the time point t4.

Then, the user may view the frame 1634 displayed at the subsequent time point t5, and follow the subsequent movement or gesture.

An operation method of a display device according to an example embodiment may be embodied as program instructions executable by various computer devices, and recorded on a computer-readable medium. In addition, an example embodiment may be implemented in a computer-readable recording medium having recorded thereon one or more programs including instructions for executing the operation method of a display device.

The computer-readable medium may include program instructions, data files, data structures, or the like separately or in combinations. The program instructions to be recorded on the medium may be specially designed and configured for the present disclosure or may be well-known to and be usable by those skill in the art of computer software. Examples of the computer-readable recording medium include magnetic media such as hard disks, floppy disks, or magnetic tapes, optical media such as compact disc ROMs (CD-ROMs) or digital video discs (DVDs), magneto-optical media such as floptical disks, and hardware devices such as ROM, RAM, and flash memory, which are specially configured to store and execute program instructions. Examples of the program instructions include not only machine code, such as code made by a compiler, but also high-level language code that is executable by a computer by using an interpreter or the like.

Here, the machine-readable storage medium may be provided in the form of a non-transitory storage medium. Here, the term ‘non-transitory’ merely means that the storage medium does not refer to a transitory electrical signal but is tangible, and does not distinguish whether data is stored semi-permanently or temporarily on the storage medium. For example, the non-transitory storage medium may include a buffer in which data is temporarily stored.

Methods according to various certain example embodiments may be included in a computer program product and then provided. The computer program products may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices (e.g., smart phones). In a case of online distribution, at least a portion of the computer program product (e.g., a downloadable app) may be temporarily stored in a machine-readable storage medium such as a manufacturer’s server, an application store’s server, or a memory of a relay server.

In detail, there may be an implemented computer program product including a recording medium having recorded thereon a program for performing an operation method of a display device according to an example embodiment.

Although embodiments have been described above in detail, the scope of the present disclosure is not limited thereto, and various modifications and alterations by those skill in the art using the basic concept of the present disclosure defined in the following claims also fall within the scope of the present disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A display device comprising:
a display;
a detector comprising at least one sensor; and
a processor configured to execute at least one instruction,
wherein the processor is configured to:
detect a gesture of a user based on a result of detection by the at least one sensor while video content is being reproduced; and
control reproduction of the video content such that at least one frame corresponding to the detected gesture among a plurality of frames included in the video content is displayed on the display.

2. The display device of claim 1, wherein the processor is further configured to identify a plurality of different movements included in the video content, and control the reproduction of the video content such that the at least one frame showing a movement corresponding to the detected gesture among the plurality of movement is displayed.

3. The display device of claim 1, wherein the processor is further configured to pause the reproduction of the video content such that the at least one frame corresponding to the detected gesture among the plurality of frames included in the video content is displayed on the display.

4. The display device of claim 1, wherein the processor is further configured to adjust a reproduction speed of the video content such that the at least one frame corresponding to the detected gesture among the plurality of frames included in the video content is displayed on the display.

5. The display device of claim 1, wherein the processor is further configured to move a reproduction point of the video content such that the at least one frame corresponding to the detected gesture among the plurality of frames included in the video content is displayed on the display.

6. The display device of claim 1, wherein the processor is further configured to identify a plurality of different movements included in the video content, and obtain information about reproduction time periods of the identified plurality of movements, and control, based on the information about the reproduction time periods, the at least one frame corresponding to the detected gesture among the plurality of frames included in the video content, to be displayed on the display.

7. The display device of claim 1, wherein the processor is further configured to analyze the video content to identify a plurality of different movements included in the video content, and perform control such that tagged video content is generated at least by inserting at least one tag corresponding to each of the identified plurality of movements into the video content.

8. The display device of claim 7, wherein the processor is further configured to control, based on the at least one tag, the at least one frame corresponding to the detected gesture among the plurality of frames included in the video content, to be displayed on the display.

9. The display device of claim 1, wherein the processor is further configured to input the result of the detection by the detector into a neural network and obtain information about the gesture of the user, the information being output as a result of computation through the neural network.

10. The display device of claim 1, wherein the processor is further configured to obtain an image corresponding to the detected gesture and control the obtained image to be displayed to be superimposed on a reproduction screen of the video content.

11. The display device of claim 1, wherein the processor is further configured to control guide information about the detected gesture, to be displayed on a reproduction screen of the video content.

12. An operation method of a display device, the operation method comprising:
reproducing video content via a display;
detecting a gesture of a user based on a result of detection by at least one sensor while the video content is being reproduced; and
controlling reproduction of the video content such that at least one frame corresponding to the detected gesture among a plurality of frames included in the video content is displayed on the display.

13. The operation method of claim 12, further comprising identifying a plurality of different movements included in the video content,
wherein the controlling of the reproduction comprises displaying, on the display, the at least one frame showing a movement corresponding to the detected gesture among the identified plurality of movements.

14. The operation method of claim 12, wherein the controlling of the reproduction comprises performing at least one of: adjusting a reproduction speed of the video content, moving a reproduction point of the video content, and pausing the reproduction of the video content, such that the at least one frame corresponding to the detected gesture among the plurality of frames included in the video content is displayed on the display.

15. The operation method of claim 12, further comprising analyzing the video content to identify a plurality of different movements included in the video content and obtaining information about reproduction time periods of the identified plurality of movements,
wherein the controlling of the reproduction comprises, based on the information about the reproduction time periods, displaying, on the display, the at least one frame showing a movement corresponding to the detected gesture among the plurality of movements.
